(19) United States
(12) Patent Application Publication
(10) Pub. No.: US 2018/0295548 A1
(43) Pub. Date: Oct. 11, 2018

(54) Predictive Roaming within an Environment

(71) Applicant: Theatro Labs Inc., Richardson, TX (US)

(72) Inventors: Ravi Shankar Kumar, Plano, TX (US); Sridhar Kovuri, Hyderabad (IN); Kranthimanoj Nagothu, Richardson, TX (US); Guy R. VanBuskirk, Spicewood, TX (US); Rupesh Sanagapalli, Pradesh (IN)

(73) Assignee: Theatro Labs Inc.

(21) Appl. No.: 15/481,574

(22) Filed: Apr. 7, 2017

(51) Int. Cl. H04W 36/08; H04W 24/08; H04W 36/38

(52) U.S. Cl. CPC H04W 36/08; H04W 36/38; H04W 24/08

(57) ABSTRACT

Methods and systems recommending handovers between access points. Handover data is collected at a central computer from a plurality of communication devices within a defined geographic area, wherein the handover data pertains to handovers between a plurality of access points as the plurality of communication devices roam within the defined geographic area. Patterns of handovers are determined at the central computer system between the plurality of access points for the plurality of communications devices. A roaming pattern is predicted, at the central computer system, for a first communication device currently connected to a first access point based on the determined patterns of handovers. A second access point within the defined geographic area is determined to be a candidate for the first communication device to handover to based, on the predicted roaming pattern of the first communication device.

### BACKGROUND

Modern communication devices provide for many communication and business analytics opportunities in retail, hospitality, industrial and other settings. Many modern communication devices are diverse and have wireless connectivity options. The wireless connectivity options may or may not follow standard protocols. Additionally, many different types of devices, systems, and/or objects may be networked including devices with electronics, software, sensors, and connectivity to enable the devices to collect and gather data to be exchanged over the network. Radio links or other wireless techniques are a common method to connect computer devices to one another.

### BRIEF DESCRIPTION OF THE DRAWINGS

FIG. 1 depicts an environment for predictive roaming in accordance with embodiments of the present technology.

FIG. 2 depicts a block diagram for access point handovers.

FIG. 3 depicts an environment for predictive roaming in accordance with embodiments of the present technology.

FIG. 4 shows the predictive roaming table created by a communication device in accordance with embodiments of the present technology.

FIG. 5 shows the predictive roaming table created by a central computer based in accordance with embodiments of the present technology.

FIG. 6 shows a Master Predictive Table (MPT) computed by a central computer in accordance with embodiments of the present technology.

FIG. 7 illustrates a flow chart for a predictive roaming process in accordance with embodiments of the present technology.

FIG. 8 is a block diagram illustrating an observation platform according to an example of the present technology.

FIG. 9 is a block diagram illustrating a plurality of observation platforms according to an example of the present technology.

FIG. 10 is a block diagram of an environment for predictive roaming for inhibiting sleep mode during contiguous conversations according to an example of the present technology.

FIG. 11 is a block diagram illustrating range extension using mobile devices as repeaters according to an example of the present technology.

FIG. 12 is a flowchart illustrating a method for recommending handovers between access points according to an example of the present technology.

FIG. 13 is a block diagram illustrating an exemplary computer system according to an example of the present technology.

### DESCRIPTION OF EMBODIMENTS

Reference will now be made in detail to embodiments of the present technology, examples of which are illustrated in the accompanying drawings. While the technology will be described in conjunction with various embodiments, it is understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving,” “storing,” “relaying,” “executing,” “generating,” “determining,” “collecting,” “predicting,” “identifying,” “recommending,” “sending,” or the like, refer to the actions and processes of a computer system, or similar electronic computing device. The computer system or similar electronic computing device, such as a wearable computer, telephone, smart phone, tablet computer, handheld mobile device, sensing device, or other connected IoT device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer system technologies such as, for example, optical, quantum and mechanical computers.

A user or users, as referred to herein, may be a person or people such as, sales associates, employees, managers, trainees, trainers, doctors, clinicians, patients, customers, emergency responders, personnel, etc. In one embodiment, the user interfaces with a device for communications with other users or interaction with external systems. Such a device may be a handheld device, a headset, a smartphone, a tablet, an earpiece, a radio, a computer system, or other device capable of providing communications across the network. Such users may be part of the enterprise operating the observation platform or they may be external to the operating entity (e.g., customers, shoppers or visitors) and desire access to users, information or control of devices within the attached data network.

Customers, employees, contractors or visitors may refer to anyone within the environment, such as a defined geographic area, who may connect to the wireless and network infrastructure by using the wearable devices or by using other applications (apps) on smartphones, tablets, laptops or other devices. In one embodiment, customers or visitors may refer to individuals who are purchasing or shopping for items or services in store or hospitality environment, past customers, potential customers, perspective customers, shoppers, browsers, or others who enter the store environment as a potential client and not with the same operational access an employee does.

The wearable device, networked mobile device, or communication device may be a personal communicator that connects users with each other, relevant computer systems, external networked devices, Internet of Things (IoT) devices, beacons, Bluetooth Low Energy (BLE) signals, and third party devices such as cellphones, smartphones, tablets, or other commercially available communicating equipment. In one embodiment, a networked mobile device is a specific purpose-built mobile or wearable communication device for use in the defined geographic area and may be used in conjunction with an observation platform. In one embodiment, the networked mobile device may not include a graphical user interface and instead relies on audio communications and physical hardware buttons. The software associated with or executing on the wearable devices monitors, extracts information, and transmits data relative to the performance of the device and it's interaction with the surrounding wireless systems.

Devices other than the wearable device or networked mobile device, such as walkie-talkies or independent smartphones, may also be used within the wireless environment through an Application Program Interface (API) developed for the system. The performance monitoring of those devices will depend on the extent of the data available through the API, the degree of control of the WiFi radio system and drivers, and from interactions with the network and the central computer.

In one embodiment, the components within the operating environment are described as an observation platform which provides the infrastructure and interfaces for collecting and analyzing the performance of the connected devices; the users operating those devices; the location and motion of those devices (if any); connecting to external databases; interconnecting Internet of Things (IoT) devices; providing in-ear training information for device usage; providing targeted training to groups, individuals or people based on their location or current actions; and/or providing verbal messaging for brand consistency and employee alignment.

### Predictive Roaming Within an Observation Platform or Any Closed Environment

The present technology is for methods and systems for predictive roaming of a communication device within a defined geographic area. The communication device in the defined geographic area may be part of an observation platform or any closed environment. In one embodiment, the defined geographic area includes a plurality of access points (APs) for a communication device to access a network connected to a central computer system. For example, the network may be a standard backhaul network and the access points may allow communication devices to access the network using standard wireless or WiFi protocols such as 802.3 or 802.11. In one embodiment, the central computer system is able to collect data pertaining to handovers between the plurality of access points for the plurality of communication devices within the defined geographic area. The central computer system is then able to determine patterns of how a communication device roams within the defined geographic area and hands over from a first access point to a second access point. The central computer system may then identify a first communication device connected to a first access point and predict where the first communication device may roam to within the defined geographic area. Based on this predictive roaming the central computer system may then determine a likely candidate or potential access point for the first communication device to hand over to as the first communication device roams. This candidate access point may be sent to the first communication device as a recommendation for handover. The first communication device may choose whether or not to handover to the candidate access point. The decision to handover may be based on additional data collected by the first communication device.

A communication device within the defined geographic area that connects to the access points may or may not execute a predictive roaming application. The predictive roaming application may be software that is installed on a communication device. The communication device may download the predictive roaming application from the central computer system or from a third party. The predictive roaming application may be used to collect and send data to the central computer system. For example, the predictive roaming application may collect data regarding the connection of the communication device to an access point. The predictive roaming application may send data to the central computer system periodically without a user's knowledge. The predictive roaming application may receive recommendations for candidate access points for the communication device to connect to next. In one embodiment, the predictive roaming application does not predict where the communication device will roam to but relies on the central computer system to make such predictions which forwards the handover recommendation directly to the predictive roaming application.

An observation platform may be a set of networked mobile devices or communication devices within a defined geographic area communicating with a central computer system that is used to monitor, relay, structure, or otherwise supervise communications between users or computer systems. The observation platform at the same time collects information about the communications and the users of the networked mobile devices and about the technical performance of the systems and platform in near real-time. The central computer system may be a single computer system, may be a plurality of computer systems working in tandem, or may rely on cloud computing techniques.

For the users, the observation platform facilitates communication between a limitless number of mobile or wearable devices and external systems using speech recognition, context and policy as a method for determining how devices are connected, what is heard, what is displayed, and what functions are performed.

A single observation platform generally covers a single geographic area such as a store, hotel, warehouse or event venue. Observation platforms may be networked together allowing transparent connections between geographies so that users and systems operate as if they were within a single geographic zone or within a single observation platform.

Within the observation platform the users perform their tasks and communicate with each other or with other systems without realizing that with each communication, and also at periodic intervals, a data set of performance factors is also transmitted. The actions, commands, and locations of the users are part of the data collected and transmitted. Additional data is gathered regarding the hardware and software performance of the wearable devices, and the supporting network and radio systems, especially data regarding signal strengths and probe responses from IEEE 802.xx access points. In one embodiment, the historical table of access point signal strength information and past handover information is searched and compared to current signal strength values to aid in the decision of the next potential handover.

The present technology assists with deploying and supporting thousands of wearable devices or networked mobile devices distributed across many observation platforms in many physical environments. In one embodiment, effective management and support of a large number of devices may be accomplished by extensive data collection and analysis of that data to enable predictive roaming for minimizing handover latency, minimize packet jitter, minimize packet corruption and maximize the quality of the user experience.

Similar to an observation platform, there may exist an environment that consists of a set of access points and one or more mobile devices that are constrained to operate within that environment. For example, a retail store or a hospitality environment may employ a set of fixed access points and a set of wireless-based devices such as smartphones, tablets, wearable computers or hand-held devices that are capable of running the predictive roaming application. Such an environment will benefit from the predictive roaming application, because, similar to operation within an observation platform, the mobile devices used within the environment are enabled by the predictive roaming application to perform and benefit from the rapid and efficient handover functions described within this specification.

One problem with devices roaming from and access point to an access point is that there is a delay during the re-association or handover as the mobile device disconnects from one access point and reconnects to the next access point. Standard IEEE protocols, such as 802.11k and 802.11r, are designed to streamline the handover and authentication of a roaming device respectively. Unfortunately, when applications are in use on the roaming devices that are sensitive to packet loss, packet jitter and packet latency, such as streaming voice or video, any delay in handovers may cause disruption or distortion of an audio or video communication.

In one embodiment, the communication devices described herein roam within a physically confined environment and may be enabled with the predictive roaming application, the communication devices accumulate a history of when handovers occur, the parameters used to direct the handover, how efficiently and quickly the handover occurred [determined by minimal packet loss, jitter, beacon loss, buffer underrun and CRC errors], and which access points were considered for the handover. This history may be communicated to and used by the central computer system to determine roaming patterns and make roaming predictions for a given communication device. The history may also be used to determine a candidate for handover to the next access point for the communication device as it roams.

Many environments use multiple access points to provide radio coverage for the geographic space and a roaming device will often have several options for handover to a new access point if the signal level is decreasing on the current access point as the device roams.

Initially, the roaming mobile device performs handovers between access points according to the standard handover routines based on the various options of the 802.11 protocol. As the mobile device captures the parameters of each handover it creates a local cache for each parameter for each handover. These parameters include the metrics used by the mobile device radio to affect handover as well as any additional Voice Quality Metrics (VQMs) that are derived from the mobile device such as packet loss, audio codec buffer underrun, and retransmit rates.

While the mobile device performs handovers as necessary using the information stored locally on the device, the central computer is simultaneously accumulating metrics for each handover based on packet loss data, packet delay data, packet jitter, application layer data and the latest handover parameters sent from the mobile device.

In this manner, the radio environment for the entire array of access points across the closed coverage environment is statistically measured, mapped, and analyzed for predicting the most successful future handovers given a set of current parameters for each mobile device as they roam throughout the environment. The central computer uses the techniques described herein, including algorithms, to map the environment and produce the list of most likely successful handover access points depending on the needs of the application running at the moment on the mobile device.

Wireless radio environments are frequently plagued with areas of weak coverage or zones of increased interference. At times, these poor coverage areas emerge almost instantaneously and the mobile device must make an instantaneous decision to handover to a new access point. More frequently, the areas of weak coverage are generally static and can be detected in the historical data of the normal roaming patterns of the mobile devices within the environment.

Any mobile device running the predictive roaming application for communicating with a central computer operating the database and processing algorithm, can be sent handover recommendations, via the predictive roaming application from the central computer system, that improve the speed and quality of a handover to a new access point. In this way, as devices roam throughout the environment, the system learns which handovers occur most frequently, which work well, which do not work well, as well as learning the typical roaming patterns from one access point to another access point. These recommendations may be used to mitigate the negative effects of weak coverage areas and assist the mobile devices in making decisions to handover to a new access point before the weak coverage area negatively affects the applications running on the mobile device.

In one embodiment, by accumulating the scan and handoff parameters for prior roaming handoffs for other mobile devices or for the same mobile device, the results of each handover and applying computer algorithms to derive roaming patterns and optimize handover choices, the central computer system can predict the best set of access points, or singular access point, for the next connection as the mobile device roams across the environment. Additional information detected by the predictive roaming application running on the mobile devices measures radio information from the WiFi device drivers, MAC-layer information from deep packet inspection, and Quality of Experience (QoE or QoX) status as provided by higher level applications interacting with the predictive roaming application.

As the system learns the environment and develops stored knowledge of handover success rates, the once unknown WiFi or other wireless environment becomes mapped to a known environment for making ultra-fast, reliable and low-loss handoffs using the predictive roaming application.

In one embodiment, selecting the best access point and best timing for handover can therefore be based on a near-real-time set of data encompassing: radio performance (signal strength, background scanning signal strengths, output power, modulation rate [uplink and downlink], and interference estimations), MAC layer performance (packet loss, packet delay, packet jitter, packet sequence, QoS), application layer performance (buffer exhaustion, buffer overrun, quality of application parameters and knowledge what processes are occurring within the application), deep packet inspection (e.g., data transfer or streaming voice), and system-level knowledge of how many mobile devices are associated with each access point. Collectively the set of information above can be called the handover elements and these elements can be used to calculate the Master Predictive Table (MPT) at the central computer. Once the handover takes place, the set of metrics immediately collected can then be processed to indicate how successful the handover was in terms of speed, packet loss and jitter. The output of the post-handover data can be summarized into a single metric called the Handover Success Metric (HSM), which is stored for future reference whenever a mobile device with similar set of near-real-time data requires a handover.

In one embodiment, the output of the central computer system calculations is a ranked list of access points for each of: 1) voice call in-progress (streaming application) and 2) non-voice call in-progress (background data exchange). The central computer system algorithm may be comprised of a calculated and dynamically weighted summary of parameters and measurements that encompass the traditional Quality of Service (QoS) physical and MAC layer measurements combined with parameters of the traditional Quality of Experience (QoE) parameters garnered from the application layer protocols. Different weighting elements will be applied depending on the nature of the primary application running on the mobile device, such as streaming voice or data-only related applications. These measurements are stored in a database on a central computer or in the cloud and may be transmitted to and replicated in part or in whole via the application on the mobile device. The mobile device may immediately capture and log the parameters gathered within the device and then supplement the local cache with parameters from the central computer table as time and bandwidth allow.

In one embodiment, a partial ranked recommended list of likely access points can be calculated locally by the mobile device with the data set of locally gathered data or may be calculated from a larger set of data if the central computer has had time to populate the other columns in the local cache. Data entries in the cache from the central computer may be time-stamped to add an element of validity to the mobile device most likely access point algorithm.

The local cache may be fully or partially populated by the central computer which is deriving the likely roaming path from the set of historical roaming results and comparing those results to the current set of values being received by the mobile device. The mobile device may periodically updates the central computer regardless if it is being used for a conversation or sitting in an idle state. Upon receiving information from the mobile device, the central computer updates the MPT and recalculates information such as, the Most Likely access point and Second Most Likely access point as well as the optional corresponding HSM. The central computer may then transmits this information to the mobile device local cache via the predictive roaming application. Transmissions from the central computer to the mobile devices occur periodically with the period being either a default set into the central computer or dynamically adapted by the central computer based on prior roaming patterns and predicted rate of handovers.

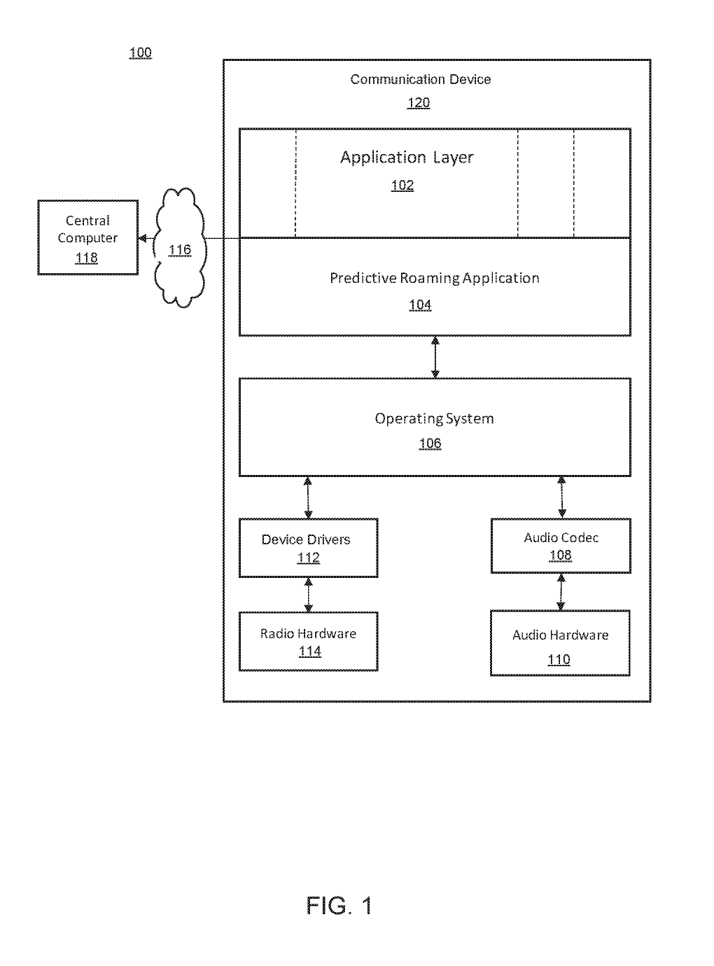

With reference now to FIG. 1, a block diagram of an environment 100 for predictive roaming according to embodiments of the present technology. The environment 100 depicts communication device 120 with the relationships of software components in using a predictive roaming application. In one embodiment, the predictive roaming application 104 provides an application programming interface (API) into other higher-level applications in the communication device 120. For example the higher-level applications may reside in an application layer 102 of the communication device 120. The present technology may be useful for the purpose of detecting degradations in application function or the user experience for applications in the application layer 102. An application in the application layer 102 may report to the predictive roaming application 104 the functional status of such elements as quality of audio being played, buffer underruns, excessive packet jitter and other issues that may relate to a degraded or failed wireless connection. The application may also report to the predictive roaming application 104 the type of application in use, such as streaming voice or simple data transfer so that optimal handover weighting factors can be employed.

In one embodiment, the application layer 102 may also be designed to operate within an Observation Platform and perform the specialized functions of a voice controlled wearable device that collects data about user activities, incorporates geographic location information and provides detailed statistics of device and user performance.

The predictive roaming application 104 is described in greater detail throughout this specification. The predictive roaming application 104 may reside as a subsystem that can take control of device drivers 112 such as WiFi device drivers based on information from: the primary applications in the application layer 102, the operating system 106, the device drivers 112, and audio coded information 108, and instructions from a central computer 118. The audio codec 108 performance information may also be imbedded in a higher-level application in application layer 102 and passed to the predictive roaming application 104 via an API.

In one embodiment, the predictive roaming application 104 periodically communicates with the central computer 118 via a network 116. The network 116 may include a WiFi and backhaul network for the purpose of exchanging information regarding the current WiFi environment being experienced by the communication device 120 and to update the communication device 120 with information used to eliminate, reduce, or trigger handovers to a different access point. The network 116 may include a plurality of access points to connect the communication device 120 to the central computer 118.

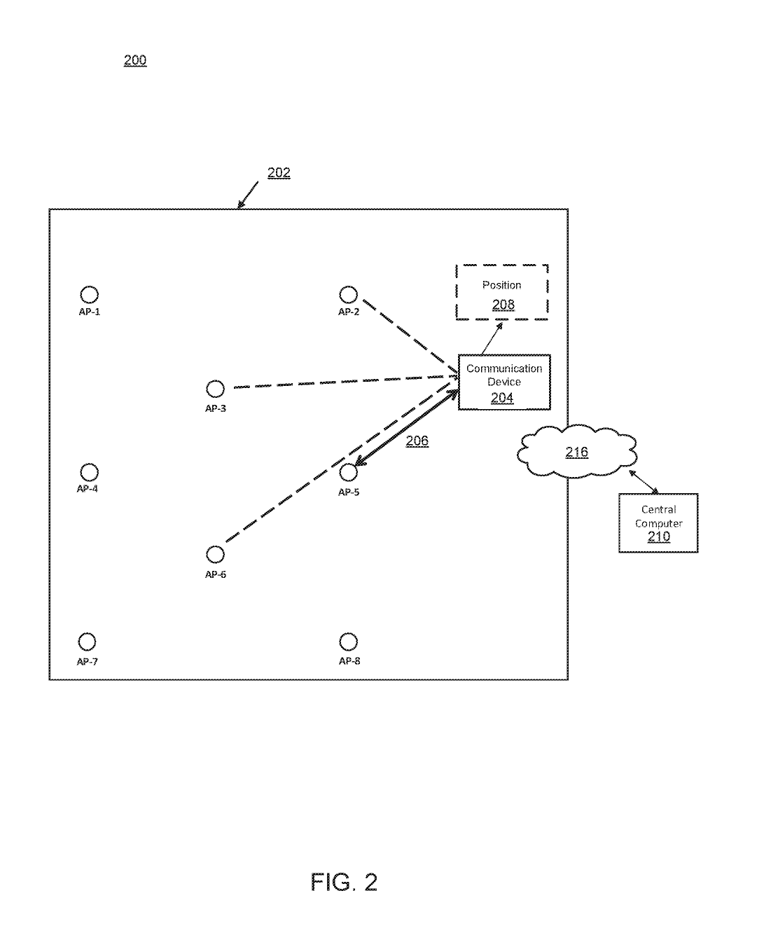

With reference now to FIG. 2, a block diagram of an environment 200 for access point handovers according to standardized procedures. The environment 200 depicts a defined geographic area 202. The defined geographic area 202 may represent a confined or closed area in which resides a plurality of access points depicted by AP-1 through AP-8. It should be appreciated that the defined geographic area 202 may comprise any number of access points. A communication device 204 is depicted near an edge of the defined geographic area 202 and is connected to (associated with) AP-5 as depicted by the arrow 206. In one embodiment, the communication device 204 is a roaming mobile device not enabled with a predictive roaming application. As the communication device 204 moves farther from AP-5 to the position 208 or encounters obstacles that block the signal to AP-5, the connection quality degrades and the standard WiFi radio driver protocols trigger a handover to different access point. These protocols typically involve the communication device 204 scanning for other access points periodically which translates into time taken away from exchanging data between the communication device 204 and the central computer 220 across the network 216. Time taken for background scanning can impact data flow and can cause a degradation of the user experience, especially for streaming applications such as audio transmissions.

The mobile device WiFi drivers of the communication device 204 can request a set of neighbor access points from the current access point, AP-5. AP-5 will send a list of known local access points to the communication device 204. Unfortunately, the list cannot contain information about how appropriate each access point would be for connection as it has no history of how devices have handed-over in the past nor does AP-5 understand how many other mobile devices are connected to each access point in the list. Using standard protocols for handover then depends on the mobile device choosing the next access point for association based on elementary elements such as received signal strength of the beacon.

In real-world environments, it may be that even though the signal strength is stronger for AP-2 in the defined geographic area 202, a better choice for handover would be AP-3, as historical connections to AP-2, given the background scan signal strength measurements, show that AP-2 has frequent dropouts or loss of signal in that geographic area.

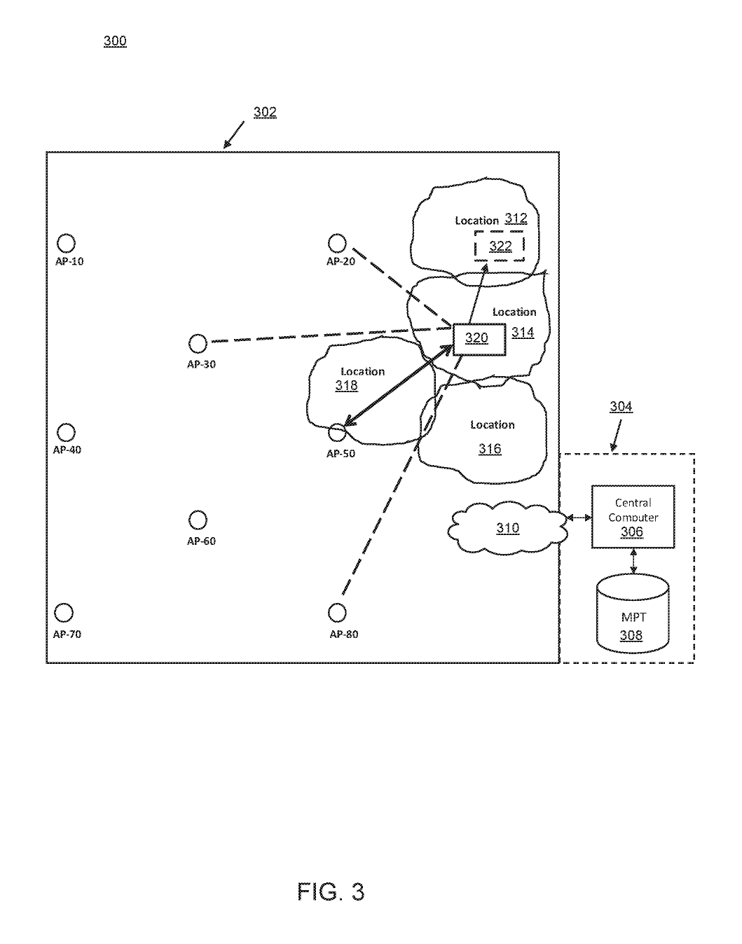

With reference now to FIG. 3, a block diagram of an environment 300 for predictive roaming according to embodiments of the present technology. The environment 300 depicts a similar environment compared to the environment 200 of FIG. 2, but is depicted with predictive roaming. In embodiments depicted by environment 300, the handover criteria and actions may be controlled directly from a predictive roaming application executing on the communication device 320 through direct connections to the WiFi radio drivers.

The environment 300 depicts a defined geographic area 302. The defined geographic area 302 may represent a confined or closed area in which resides a plurality of access points depicted by AP-10 through AP-80. It should be appreciated that the defined geographic area 302 may comprise any number of access points. The environment 200 depicts the communication device 320 near an edge of the defined geographic area 302 and is connected to the AP-50 as depicted by the solid doubled headed arrow. The communication device 320 may have a predictive roaming application enabled. The communication device 320 is depicted in a geographic zone within the defined geographic area 302 as depicted by location 314. The defined geographic area 302 also depicts locations 312, 316, and 318. As Device the communication device 320 moves farther from AP-50 or encounters obstacles that block the signal to AP-50, the connection quality degrades and multiple measurements monitored by the predictive roaming application are weighted and computed by the communication device 320 to determine if a handover to different access point is required. The communication device 320 is depicted with an MPT 308 which is a database for a Master Predictive Table. The communication device 320 and the MPT 308 are depicted in the region 304. The region 304 may be located within or without of the defined geographic area 302. The central computer 306 and the MPT 308 may be located physically close to another or may be remote. The central computer 306 may be one computer system or a plurality of computer systems.

In one embodiment, the communication device 320 maintains a local cache of reference information for handover assistance. The local cache may up updated locally from background scanning information as well as connection quality information provided by the predictive roaming application or higher-level applications. Additional information to assist in handover may be received from the central computer 306 to increase the local information for improved handover speed and success.

In one embodiment, the communication device 320 continually updates the local cache with signal strength and background scan values from the on-board WiFi drivers or other wireless drivers. By communicating with the central computer 306, the local cache is expanded by synchronizing additional data with the MPT 308 from the central computer 306. For example, as the communication device 320 moves away from AP-50 to the position 322 in location 213, and the predictive roaming application detects a degradation of performance, the local cache may indicate that most likely access points for connection are AP-20, AP-50 and AP-80. The local cache, now synchronized with MPT 308, may further indicate that only one of these access points, AP-80, is the best access point for handover. If the MPT 308 shows a best choice with high confidence, the handover may take place without background scans and with minimal handover time. If the MPT 308 shows that there may be an ambiguity in the choice of “best” access point, the predictive roaming application may initiate a limited background scan of one or more of the ranked set of most likely access points, in this example, AP-20, AP-50 and AP-80. In normal operation, the MPT 308 will indicate the best and second-best access point for both streaming and non-streaming traffic. The predictive roaming application on the mobile device then determines the type of traffic in process and selects the correct access point for handover.

### Computing the Master Predictive Table (MPT)

In one embodiment, the central computer may derive and maintain a comprehensive predictive roaming table using data provided by the mobile device as well as data derived at the central computer from sources such as the communication as measured by the radio access point, MAC layer information (packet loss, packet jitter, packet delay, deep packet inspection to determine the type of packet) and application layer parameters such as audio buffer underrun or radio power settings determined and stored prior to and following the handover.

Additionally, the frequency of handover from a specific access point to a specific neighbor access point and the degree of success for each handover allows the central computer to learn the behavior of the handovers and the mobile devices that are traversing the environment and connecting to the wireless network.

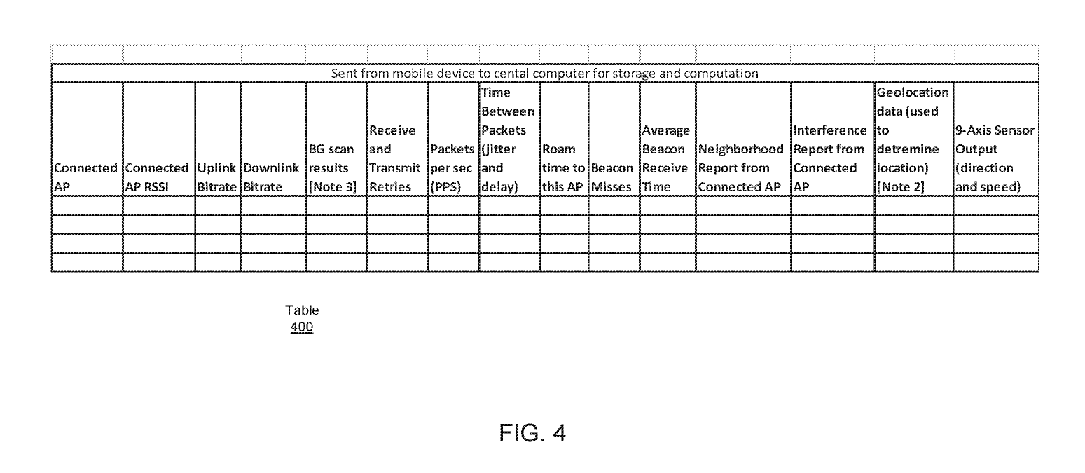

With reference now to FIG. 4, that depicts a table 400 according to embodiments of the present technology. The table 400 is a table of information that may be collected by the predictive roaming application running on a mobile device. The table 400, along with other information such as index numbers and data-stamps may be periodically transmitted to the central computer for computing the ranked list of most likely access points for handover. The table 400 displays several categories for information or data that may be collected or generated by the mobile device. The blank spaces in the table 400 may be filled in with values corresponding to the category for the given column.

In one embodiment, the predictive roaming application running on the mobile device collects and caches data in the table 400. The data may pertain to one or more of the following metrics for forwarding to the central computer. Not all metrics are collected at the same time and each metric may have a separate timestamp and index number associated with it.
a. Connected access point
b. Connected access point signal strength (RSSI)
c. Data rate (uplink and downlink)
d. Background scan results for each AP
e. Receive and transmit retries
f. Packets per second
g. Packet delay and jitter (time between packets)
h. Roam time to the current access point
i. Missed beacon counts per measurement interval
j. Average beacon receive time
k. Neighbor access point list from the currently connected access point
l. Interference report from the currently connected access point
m. Data used to derive the geolocation of the mobile device
n. 9-Axis inertial sensor output (direction and speed)

In one embodiment, the table 400 contains the MAC address of the connected access point and the corresponding signal strength (RSSI). The uplink and downlink bitrates are read from the radio device drivers. Background scan results depend on the list of likely access points and how many access points are scanned in the background. In one embodiment, if the central computer has updated the mobile device with the most likely access points for handoff information, the background scan may be limited to the most likely access points or completely inhibited and the background scan values will be reduced or omitted. If the predictive roaming application determines the application is streaming voice, background scanning may also be inhibited or reduced to a set of the most likely access points for connection. Limiting the background scan process allows the streaming application to continue with minimal interruption and buffering.

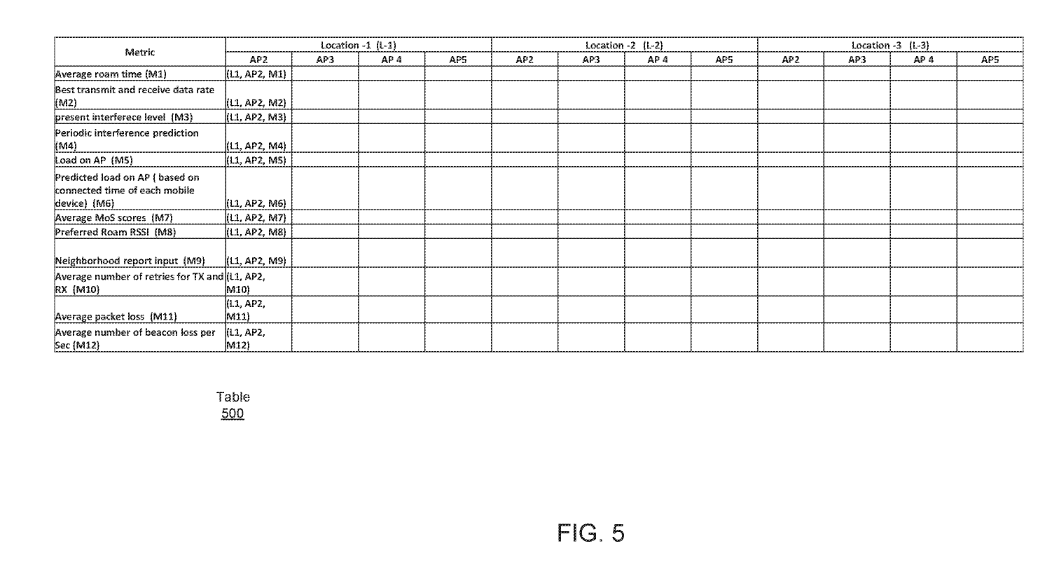

With reference now to FIG. 5, which depicts a table 500 according to embodiments of the present technology. The table 500 depicts a portion of a master predictive table (MPT) created by a central computer for deriving the most likely handover access points. The table 500 shows three separate location zones [L-1], [L-2], [L-3] which correspond to the location of the mobile device as determined by a separate algorithm. For example, [L-1], [L-2], [L-3] may correspond to locations 312, 314, and 316 of FIG. 3 respectively. Table 500 depicts three locations; however, table 500 may include fewer or more locations. Within each location [L-1], [L-2], [L-3] there are entries for each candidate access point based on either current or historical values.

In one embodiment, the average roam time [M1] is computed by averaging the historical roam times of mobile devices that have been in the given location and have connected to the access points as shown. The averaging interval may be determined by the central computer and may be adjusted depending on the number of mobile devices that roam in the given location over a given time or as needed to optimize the average roam time calculation. The roam time may indicate the time it takes a mobile device to associate with and begin data exchange with the indicated access point. An example of the roam time calculation is shown table 1 below:

TABLE 1
Computation of Average Roam Time
Location-1

| | AP1 | | | | AP2 | | | |
|---|---|---|---|---|---|---|---|---|
| | 1^{st} | 2^{nd} | 3^{rd} | | 1^{st} | 2^{nd} | 3^{rd} | |
| | instant | instant | instant | Cumulative | instant | instant | instant | Cumulative |
| Mobile Device | 100 | 120 | 90 | 103.33 | 110 | 130 | 140 | 126.67 |
| A | | | | | | | | |
| Mobile The | 90 | 110 | 120 | 106.67 | 115 | 132 | 135 | 127.33 |
| communication | | | | | | | | |
| device 320 | | | | | | | | |
| Average | | | | 105 | | | | 127 |

In one embodiment, the system may learn which transmit and receive data rates [M2] are optimal as mobile devices enter the location (e.g., [L-1]) and handover to the indicated access points. Each time a handover is made to a given access point from the given location, the data rates and quality of the data stream may be evaluated and stored. The central computer may then use this history to establish the data rates that perform the best when a mobile device is in the given location and attempting to handover to the given access point.

The present interference level [M3] may be reported by the mobile devices using the predictive roaming application and may be used as a baseline for anticipating the interference that can be expected for a handover. Related to the baseline level is the periodic interference prediction which uses historical interference patterns to predict current interference levels. For example, it may be that 2:00 PM on Wednesdays, a gathering of people using WiFi enabled devices gather in location 1 [L-1] for a meeting. The large number of communicating devices in L-1 may indicate that connecting to a more distant access point would provide a faster handover and higher data rate.

In one embodiment, the number of devices connected to a given access point may be called the load on the access point [M5] and because the central computer receives a nearly continuous stream of information from all of the mobile devices running the predictive roaming application, the central computer knows how many devices are currently connected to any access point. In addition, by timing the connection from a given mobile device, calculating the velocity of the mobile device as it changes location and knowing the history of that mobile device and the user of that device, the central computer can predict that one or more mobile devices may enter or exit a given location in the near future, thus enabling a prediction of the future load on a given access point. The predicted value may be stored in the MPT as [M6].

In one embodiment, value [M7] may be called the MoS number and may be calculated by a separate algorithm which takes into consideration packet loss, packet delay and packet jitter. Using these raw values, an estimation of the quality of streaming audio may be determined. MoS may be an application-level parameter calculated with metrics measured at the MAC and radio driver level.

In one embodiment, the preferred roam receive signal strength indicator (RSSI) [M8] represents a threshold value for which the mobile device should initiate a handover if the RSSI may be above this value, or for which the mobile device should not attempt a handover if the RSSI is below this value. In one embodiment, the preferred roam RSSI [M8] may be based on past handovers from devices in the given location attempting to handover to the given access points.

The Neighborhood report input [M9] may be a collection of nearby access points as reported by the currently connected access point. The central computer uses this information (M5 and M6 for all access points) to aid in determining which will be the best access point for a handover.

In one embodiment, the WiFi drivers may keep track of the number of retries [M10] for sending and receiving packets in the WiFi radio module. The number of retries may be another indicator of the quality of the WiFi connection and will be used in the calculation for the optimal handover access point.

The average packet loss [M11] may count the number of packets missing or with CRC errors as a gross measure of signal quality and interference effects. The central computer uses packet loss information to aid in determining the setting for the data rate and determining the optimal handover access point.

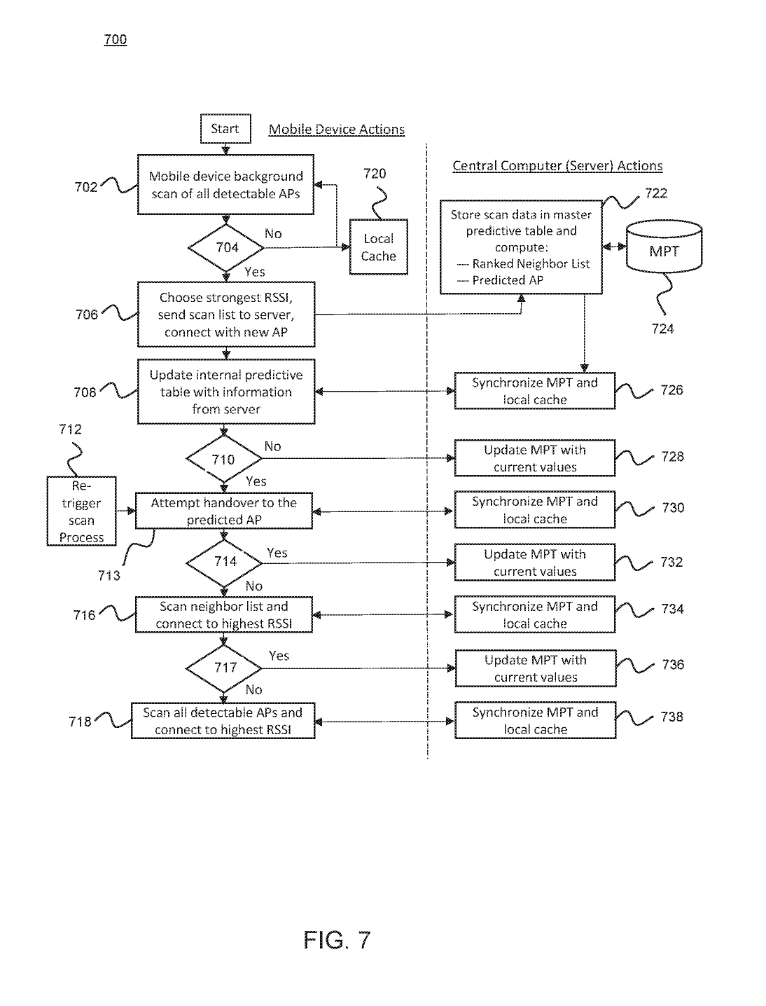

In one embodiment, beacons may be set with 100 mS intervals and arrive at the rate of 10 beacons per second. A metric that tracks a number of beacon loss per second [M12] may be used by the central computer to make handover decisions based on prior beacon integrity information. Loss of too many beacons in an interval of typically three (3) seconds, may force a handover according to the handover triggering process described process 700 of FIG. 7.

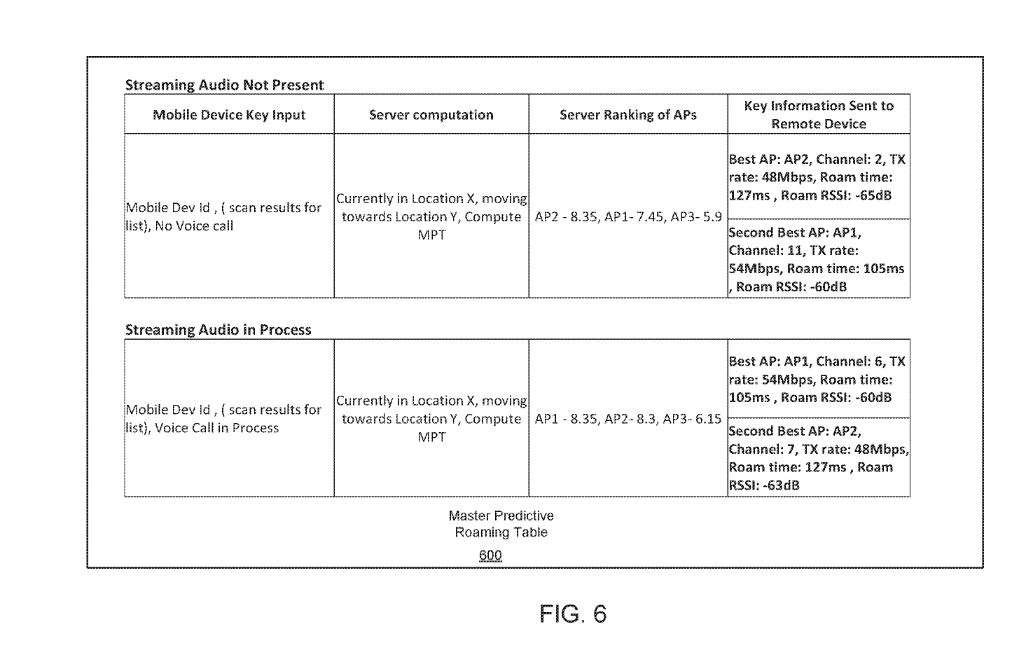

With reference now to FIG. 6, which depicts a master predictive roaming table 600. The master predictive roaming table 600 shows at least partially filled in with values that may be used by a central computer to calculate an access point, including a most likely access point, for an efficient high quality handover from one access point to another access point for a mobile device.

Table 2 below is an example of table 500 of FIG. 5 at least partially filled in with values for a plurality of access points. The values of table 2 may be used by a central computer to calculate an access point, including a most likely access point, for an efficient high quality handover from one access point to another access point for a mobile device.

TABLE 2

| | Location-1 | | | | Location-2 | | | | Location-3 | | | |
|---|---|---|---|---|---|---|---|---|---|---|---|---|
| Metric | Ap1 | Ap2 | Ap3 | Ap4 | Ap1 | Ap2 | Ap3 | Ap4 | Ap1 | Ap2 | Ap3 | Ap4 |
| Average roam time (M1) | 105 | 127 | 130 | 140 | 150 | 90 | 110 | 120 | 130 | 120 | 70 | 100 |
| Average transmit and receive bit | 54 | 48 | 48 | 36 | 24 | 54 | 54 | 48 | 36 | 48 | 54 | 54 |
| rate (M2)(Mbps) | | | | | | | | | | | | |
| present interference | 0 | 1 | 5 | 4 | 0 | 5 | 7 | 8 | 9 | 0 | 5 | 1 |
| level(M3)(0-NIL 10-High) | | | | | | | | | | | | |
| Periodic interference | 5 | 4 | 5 | 7 | 4 | 4 | 0 | 1 | 10 | 0 | 1 | 1 |
| prediction(M4)(0-NIL 10-High) | | | | | | | | | | | | |
| (interference observed at the | | | | | | | | | | | | |
| same time on previous 7 days) | | | | | | | | | | | | |
| Load AP(M5)(Number of devices | 4 | 0 | 4 | 3 | 0 | 5 | 5 | 5 | 6 | 7 | 0 | 3 |
| connected to AP) (0-Low 10- | | | | | | | | | | | | |
| high) | | | | | | | | | | | | |
| Predicted load on AP (based on | 3 | 1 | 3 | 3 | 0 | 7 | 7 | 5 | 6 | 7 | 3 | 1 |
| connected time of each | | | | | | | | | | | | |
| C2)(M6)(estimated load for next | | | | | | | | | | | | |
| 1 hr based on past history) | | | | | | | | | | | | |
| Average MoS scores(M7)(0-bad | 4 | 4 | 3 | 3 | 2 | 4 | 4 | 3 | 3 | 4 | 5 | 3 |
| 5-excellent) | | | | | | | | | | | | |
| Preferred Roam RSSI (M8) | 60 | 65 | 67 | 70 | 70 | 60 | 65 | 68 | 70 | 65 | 60 | 65 |
| Neighborhood report input (M9) | 0 | 1 | 0 | 0 | 0 | 1 | 0 | 0 | 0 | 0 | 0 | 1 |
| (1-recommended, 0-not | | | | | | | | | | | | |
| recommended) | | | | | | | | | | | | |
| Average number of retries for TX | 1 | 1 | 3 | 3 | 5 | 1 | 1 | 2 | 3 | 2 | 1 | 1 |
| and RX (M10) (0-Good, 10- | | | | | | | | | | | | |
| many retries) | | | | | | | | | | | | |
| Average packet loss (M11) (0- | 1 | 2 | 3 | 3 | 4 | 1 | 1 | 3 | 3 | 1 | 1 | 1 |
| Nil , 10-High) | | | | | | | | | | | | |
| Average number of beacon loss | 1 | 1 | 2 | 2 | 2 | 1 | 1 | 1 | 3 | 3 | 1 | 1 |
| per Sec (M12) | | | | | | | | | | | | |

Table 3 below demonstrates how additional calculations may be used by the central computer to reduce the complexity of numerical values to relative values for future calculations. The table 3 shows a reduction of the values for [M1], [M2] and [M8] of table 2 to normalized values between 1 and 10.

TABLE 3

| | | | | | | | | | | | | |
|---|---|---|---|---|---|---|---|---|---|---|---|---|
| Average roam time(M1) (Below 100-0, | 1 | 3 | 3 | 4 | 5 | 0 | 2 | 3 | 4 | 2 | 0 | 1 |
| above 200-10) | | | | | | | | | | | | |
| Average transmit and receive bit | 0 | 1 | 1 | 2 | 3 | 0 | 0 | 1 | 2 | 1 | 0 | 0 |
| rate(M2)(mbps)(54-0, 6-8, 11b-0) | | | | | | | | | | | | |
| Preferred Roam RSSI(M8)(60 and below 0 | 0 | 2 | 3 | 4 | 4 | 1 | 2 | 2 | 4 | 2 | 0 | 2 |
| (good), 75 above 10(bad)) | | | | | | | | | | | | |

Table 4 below demonstrates how the information in the partial MPT of table 2 and/or table 3 may then be weighted and calculated using weighting factors as set as defaults or dynamically calculated.

TABLE 4

| Example for description | | | | | | | | | | |
|---|---|---|---|---|---|---|---|---|---|---|
| purpose only, actual weights | | | Ranking of AP (Roam time, data rate and RSSI | | | | | | | |
| might vary | | | check below for multiplication factor) | | | | | | | |
| Weighting | No | Voice in | Location - 1 (no Voice) | | | | Location - 1 (Voice) | | | |
| Factors | Voice | progress | AP1 | AP2 | AP3 | AP4 | AP1 | AP2 | AP3 | AP4 |
| W1 | 0.15 | 0.25 | 1.35 | 1.05 | 1.05 | 0.9 | 2.25 | 1.75 | 1.75 | 1.5 |
| W2 | 0.05 | 0.075 | 0.5 | 0.45 | 0.45 | 0.4 | 0.75 | 0.675 | 0.675 | 0.6 |
| W3 | 0.075 | 0.2 | 0.75 | 0.675 | 0.375 | 0.45 | 2 | 1.8 | 1 | 1.2 |
| W4 | 0.075 | 0.025 | 0.375 | 0.45 | 0.375 | 0.225 | 0.125 | 0.15 | 0.125 | 0.08 |
| W5 | 0.075 | 0.075 | 0.45 | 0.75 | 0.45 | 0.525 | 0.45 | 0.75 | 0.45 | 0.53 |
| W6 | 0.075 | 0.025 | 0.525 | 0.675 | 0.525 | 0.525 | 0.175 | 0.225 | 0.175 | 0.18 |
| W7 | 0.15 | 0.15 | 1.2 | 1.2 | 0.9 | 0.9 | 1.2 | 1.2 | 0.9 | 0.9 |
| W8 | 0.05 | 0.05 | 0.5 | 0.4 | 0.35 | 0.3 | 0.5 | 0.4 | 0.35 | 0.3 |
| W9 | 0.1 | 0.05 | 0 | 1 | 0 | 0 | 0 | 0.5 | 0 | 0 |
| W10 | 0.05 | 0.025 | 0.45 | 0.45 | 0.35 | 0.35 | 0.225 | 0.225 | 0.175 | 0.18 |
| W11 | 0.1 | 0.05 | 0.9 | 0.8 | 0.7 | 0.7 | 0.45 | 0.4 | 0.35 | 0.35 |
| W12 | 0.05 | 0.025 | 0.45 | 0.45 | 0.4 | 0.4 | 0.225 | 0.225 | 0.2 | 0.2 |
| | | | 7.45 | 8.35 | 5.93 | 5.68 | 8.35 | 8.3 | 6.15 | 6 |

### Predictive Roaming Handover Triggering

With reference now to FIG. 7, a flowchart for a predictive roaming handover process 700 according to embodiments of the present technology. The predictive roaming handover process 700 describes an embodiment that begins with the assumption that the mobile device is being initially turned on or has just entered the physical environment. At this point the mobile device has no history in the network and is not associated with any access point. In alternate embodiments a flow may be described with a device that has a history in the physical environment. The mobile device then uses well understood and standard wireless protocols, such as 802.11k and 802.11r or others, to determine which access point in the network would provide a reliable connection to the network and hence the central computer. In one embodiment, the central computer may recognize the new mobile device in the environment, and using the accumulated results of the plurality of existing mobile device roaming information, simply download typical MPT results as depicted in 708, thereby quickly enabling the new mobile device to take advantage of the predictive roaming application immediately. It should be appreciated that the predictive roaming handover process 700 is one example of the present technology which is not limited to this process.

The step 702 represents a scanning mode for a standard WiFi radio devices and decision 704 represents a decision making inherent in the standard protocols as mentioned above. If the scanning process does not result in a satisfactory access point for association, the results of the scan may be stored in a local table and the scan will be repeated until a suitable access point is found for association. Each time a background scan is processed, the results may be stored in a local cache 125 for use by the predictive roaming application or for later transmission to the central computer.

If decision 704 determines that one or more of the scanned access points are above the minimum acceptable threshold, the radio will associate with the access point with the highest received signal strength indicator (RSSI), hence the strongest signal at the moment as shown in step 706. If decision 704 does not find any scanned access point with a sufficiently strong RSSI, the scan repeats typically every 100 milliseconds until an access point is detected with an RSSI above the sufficient threshold. The scan interval may be changed upon command by the central computer in order to optimize the handover process. Simultaneously, the predictive roaming application may store the scan results of any access point scanned in a local cache 125 for later transmission to the central computer for storage, analysis and predicting a most likely handover access point in the future. This allows for the central computer to begin to learn the patterns of the scan results and begin to derive a table of ranked access points for the most likely handover should similar scan results be detected in the future.

Step 706 not only directs the radio driver module to associate with the access point having the strongest RSSI, but since the mobile device is now connected to the network through that access point, the predictive roaming application may transmit the set of scan results captured in the local cache 125 to the central computer. The central computer uses step 722 to categorize and store the information received from each mobile device and begins to compute a ranked neighbor list of access points based on the information collected from the roaming mobile roaming devices and the information collected from the receive side of packets arriving at the central computer for processing within the superset application. A database that stores this information then becomes the Master Predictive Table (MPT) 724 for all roaming devices.

The MPT 724 may be a growing and dynamic table comprising raw data elements for one or more of:
a. Background scan RSSI values
b. Packet loss (CRC error counts) values
c. Beacon loss counts
d. Packet jitter values
e. Packet delay values
f. Audio codec buffer underrun values
g. Handover delay values
h. Mobile device location (as determined by a separate application)
i. Mobile device motion (as determined by inertial systems on the mobile device)
   Additionally, the MPT 724 may also contain one or more information elements derived by the central computer for:
a. Neighbor access point list based on scanned RSSI values
b. Ranked neighbor access point list based on RSSI values and past handover performance
c. Most likely handover access point recommendation based on computation from the raw data above.
d. Updated handover trigger criteria based on past results from handovers from a plethora of mobile devices.

Now that the mobile device is connected to central computer via the wireless or WiFi network and backhaul network, the central computer can transmit portions of the MPT 724 to the mobile device for assisting in handovers via step 726. Step 726 prepares the relevant sections of the MPT 724 for transmission to the mobile device during the next data transmission. At this point, the mobile device may have its local cache of RSSI values and link quality information augmented by additional information from the MPT 724 in the form of a ranked list of the most likely access points reflecting the history of handovers to each access point and the relative success of handover selection as shown in step 708.

The decision criteria for initiating a handover at decision 710 is now expanded to include MAC layer information, information from the central computer such as the number of mobile devices connected to the current access point, and the current state of the application for audio processing. The scanning process can also be triggered at any time based on the algorithm described below as shown by block 712. There may be different threshold values for streaming data such as voice and non-streaming data such as geolocation information.

If the application is not currently sending or receiving audio streams, the criteria used for decision 710 is reduced to beacon and signal strength information as follows:

Initiate handover routine if one or more of the following is true:
1. less than (a) beacons per second are received for (b) sequential seconds as measured by the mobile device radio driver
2. the RSSI level has dropped below (c) dB as measured by the mobile device radio driver.
   Where, for example, typical values may be a=10 beacons received within one second (assuming a beaconing rate of one every 100 mS) and b=3 sequential seconds of beacon monitoring. The values for received signal strength for which a handover is indicated is initially a default value, for example, c=−80 dB or may be a value sent to the predictive roaming application based on handover effectiveness for the specific mobile device (as identified by the MAC address) or based on historical learning of the environment, for example, in this geographic location with the current set of scan values, the threshold for c=−88 dB.

If the above criteria indicates that all WiFi parameters are above threshold levels and that a high-quality connection is in progress, the decision at 710 is to not make a handover (No) and the predictive roaming application sends an update of the latest parameters in the local cache 720 to the central computer to analyze and add to the MPT 724 for future reference.

If the above criteria indicates that a handover may be necessary, the predictive roaming application may turn off power saving mode at 710 before triggering a handover to determine if contention is a factor in beacon loss. If the above criteria continues to indicate that a handover may be necessary, then the handover is initiated at decision 710.

If the application is currently sending or receiving audio streams, meaning the user of the mobile device is in a conversation or listening to audio information, an expanded set of criteria is invoked for initiating the handover routine. In the case of audio streaming in progress, the following criteria is applied for decision 710:

Initiate handover routine based on a weighted combination of the following elements:
1. less than (a) beacons per second are received for (b) sequential seconds as measured by the mobile device radio driver
2. the RSSI level has dropped below (c) dB as measured by the mobile device radio driver
3. packet loss (CRC error counts) are greater than (d) percent averaged over (e) interval
4. packet jitter greater than (f) milliseconds
5. packet delay greater than (g) milliseconds
6. audio codec buffer underrun greater than (h) milliseconds
7. the number of mobile devices running the predictive roaming application connected to the current access point exceeds a threshold value of (i) devices
8. the predictive roaming application detects another anomaly for which a handover may improve the operation
9. the predictive roaming application uses the MPT 724 information forwarded to the local cache 720 and determines there is a better access point choice even though the current access point connection is adequate.
   If the above criteria indicates that a handover may be necessary, the predictive roaming application may turn off power saving mode before initiating a handover to determine if contention is a factor in the degradation of any one or more decision elements. Alternatively, if the predictive roaming application determines via the local cache updated with the values from the MPT 724, that a neighboring access point has a high likelihood of a solid connection, step 713 may immediately initiate the handover.

In one embodiment, one or more of the above elements has degraded and the mobile device must determine the likelihood of a beneficial handover by weighting the elements 1-7 above and computing the necessity of a handover. Part of that decision analysis may include the likelihood of successful handover based on information provided from the central computer and portions of the MPT 724. Hence the decision for triggering the handover routine can be summarized as demonstrated in equation 1:

X*(the weighted combination of elements 1-6 above)+Y*(confidence interval for most likely access point choice) Equation 1

In equation 1, X represents how badly the connection is affecting the user experience and Y represents how much of an improvement might be possible following a handover to the most likely access point as determined by the MPT 724.

X and Y in equation 1 begin with default values and are then empirically adjusted by the central computer based on prior handover records from a plethora of mobile devices running the predictive roaming application and calculating the effectiveness and speed of each successive handover. The central computer may employ standard statistical techniques using classical frequentist analysis of effectiveness of handover or may employ Bayesian techniques to apply a distribution of coefficients and adjust values, and then using the new values in handovers for measure the results. These techniques may be applied to top-level handover values for X and Y, and may be also applied to the coefficients of the parameters shown in elements 1-7 above.

In one embodiment, decision 710 may be forced to initiate a handover if elements 8 or 9 above determine that a handover needs to be forced. The predictive roaming application may detect the need for a handover based on additional parameters such as geographic location or being informed by the central computer that there are too many mobile devices running the predictive roaming application on a given access point.

The step 713 initiates the handover by looking up in the local cache 720 which access point is the best choice as determined by the central computer, loaded into the MPT 724, and forwarded to the mobile device local cache 720 by forwarding steps 726, 730, 734, and 738. Step 713 then instructs the WiFi radio via the WiFi device driver to associate with the selected access point.

Following the handover attempt, the WiFi device driver reports that the connection was established or declined. This information is used at decision 714 to determine if background scanning should be enabled in the event that the handoff was unsuccessful. If the connection is established, but the weighted measurement of the parameters described in elements 1-7 above are below the threshold value, the neighbor list for scanning may be expanded by background scanning additional access points as selected from the local cache 720 as updated by the MPT 724 and the table synchronization step 734. The expanded scanning and handover step 716 then attempts to associate with the access point whose beacon strength is the strongest from the ranked and limited list of access points provided by the MPT 724.

Following the handover attempt, the WiFi device driver reports that the connection was established or declined. This information is used at decision 717 to determine if full background scanning of all detectable access points should be enabled in the event that the handoff was unsuccessful. If the connection is established, but the weighted measurement of the parameters described in elements 1-7 above are below the threshold value, the WiFi device driver is instructed to perform a full or partial background scan of all detectable access points. The expanded scanning and handover step 718 then attempts to associate with the access point whose beacon strength is the strongest. At 728, 732, and 736 the MPT is updated with a current value.

### Observation Platform

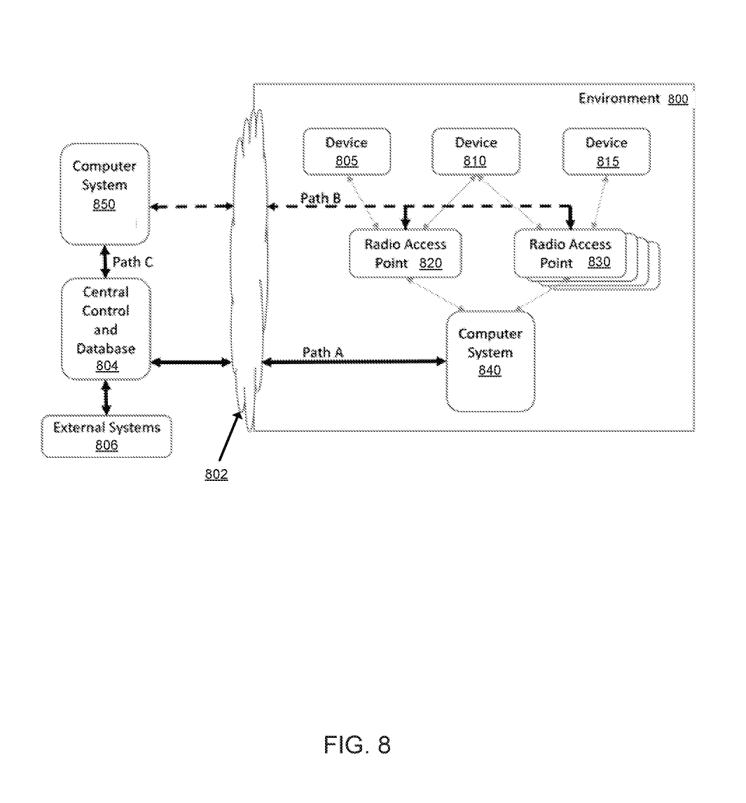

With reference now to FIG. 8, a block diagram of an observation platform. The observation platform described in FIG. 8 may be used in conjunction with the present technology for predictive roaming for recommending a hand over access point. For example, the device 805 may be used in FIG. 8 in conjunction with the observation platform and may also be a communication device that receives a hand over recommendation to hand over from radio access point 820 to radio access point 830. The computer system in FIG. 8 may serve functions within the observation platform and may also serve as the central computer as described herein for predictive roaming and for recommending a hand over access point. An environment 800 describes a physical location of a basic observation platform. Within the environment 800 are devices 805, 810, 815 which each represent one or a plurality of communication devices. It should be appreciated that the observation platform may comprise any number of communication devices. These communication devices may communicate using wireless signals connecting to radio access points 820 and 830 within the environment 800. The radio access points 820 and 830 depict antennas or other transceivers associated with the observation platform that can send or receive wireless communications. The devices 805, 810, 815 may be owned by the enterprise associated with the observation platform, owned by the user, or owned by the observation platform provider and may be, for example, a smartphone, a tablet computer, a wearable device, a personal digital assistant, a fob, a handheld device, a headset device, or other small electronic device.

The devices 805, 810 and 815 may be user devices that are mobile and employed by a user to communicate with other users via other devices. Communications between the devices 805, 810 and 815 may be described as signals. In one embodiment, the devices 805, 810 and 815 employ speakers and microphones with control buttons for audible communications. The control buttons may be press-to-signal buttons, push-to-talk buttons, volume control buttons, and power on/off buttons or other standard buttons and may be options on a touchscreen. The devices 805, 810 and 815 may be handheld, may be worn around the neck, clipped to clothing, worn on the wrist, or may be a headset worn on the head or behind the ear or otherwise interface with the human body. The devices 805, 810 and 815 may or may not comprise a screen or display such as a liquid crystal display (LCD) or touch screen. In one embodiment, devices 805, 810 and 815 do not comprise a display such that a user is not inundated with too many options or too much information from the device. A user device without a display may simplify communications and thus allow heads-up awareness and presence in the environment. Another user, such as a customer, may be more likely to employ the device for its intended purpose if the human interface is simplified.

The devices 805, 810 and 815 and other devices in environment 800 may be dispensed to a user upon entering environment 800 or may be brought by the user into environment 800. For example, in a retail setting associates may be issued devices by the employer or owner of the retailer setting. Customers in the retail setting may also be issued devices as they enter the retail setting or be offered an application that runs on a customer-owned device. Customers may choose whether to accept the device and application or whether or not to use the device or application after accepting it. The devices 805, 810 and 815 may represent more than one type of communication device. For example, associates or employees of the environment associated with the observation platform may or may not use the same type or model of devices as customers of the environment. Alternatively, the customer may bring a device into the retail setting such as a smartphone. The customer may download an app to the smartphone that will allow the customer to use the device for communications in the store with associates or others in accordance with present technology. The customer may remain anonymous or may elect to identify themselves. In one embodiment, recognition of the customer's identity is not required for additional services or offers.

The environment 800 may comprise multiple radio access points 820 and 830 and access point technology may include Wi-Fi, Bluetooth, private radio or other wireless connections. An environment and may contain a single or a plethora of radio access points as shown. In one instance, a computer system 840 exists within the environment 800, and by using standard computer networking technologies such as switches, bridges, routers, firewalls, gateways, etc., the radio access points communicate with each other and with the computer system 840. The computer system 840 communicates via standard networking technologies, possibly including the internet, to the central control and a database such as central control and database 804 using bi-directional Path A. Path A may pass through network 802 which may be the internet, a local network, or another network. The computer system 840 may comprise more than one computer system and may be optional in the physical location of environment 800. For example, the computer system 840 may rely on cloud computing techniques with computing systems or resources located in remote network.

In an embodiment where the computer system 840 is not included in environment 800, Path B is used to communicate between the radio access points 820 and 830 and a computer system 850 that is an external computer system, that may reside in the cloud, in the enterprise, or at the service provider for the observation platform. In one embodiment, the environment 800 relies on a computer system such as the computer system 840 or the computer system 850 in order to operate. It is possible to configure an observation platform with both computer system 840 and computer system 850 connected for purposes of redundancy or to share computational load.

The radio access points 820 and 830 and the devices 805, 810, 815 may employ standard techniques for communicating wirelessly. The communications may be performed using radio techniques such as near field communications, short wave radio, infrared, Bluetooth, Low Energy Bluetooth (BLE), WiFi, standard wireless computer network protocols, etc. The devices 805, 810 and 815 may be able to communicate with each other directly or through access points 820 and 830. The devices 805, 810 and 815 communicate with each other via the computer system 840 or 850. In one embodiment, all communications in the environment 800 are relayed through the radio access points that act as a central hub. For example, the device 805 may communicate with the device 810 by the device 805 sending a communication to the radio access point 820, the computer system 840 derives that the device 810 is the destination for the communication and relays the communication to device 810. This may occur automatically and quickly enough such that the users will not experience any undue lag in communications. In one embodiment, the devices 805, 810, and 815 may communicate directly with the computer system 840. For example, a user may issue a command to the computer system 840 via the device 805 or the computer system 840 may send information to the device 805. Information send from the computer system 840 to the device 805 may be an audible voice signal or may be textual, contextual, geographical or graphical data to be displayed at the device 805 if it is properly equipped to do so.

The computer systems 840 or 850 are responsible for the structuring of communications and collection of analytical data from the devices 805, 810, and 815. The computer system 840 or the computer system 850 report data to the central control and database 804 using either Path A or Path C as indicated. Additionally, the central control and database 804 may provide information, instructions, messages, configuration data, and/or policy information to the computer system 840 or the computer system 850 for structuring and controlling the communication flow to and among the Devices within Environment 800. The central control and database 804 contains the instructions for policy distribution to the computer system 840 or the computer system 850. The central control and database 804 accumulates the primary statistics and processes the algorithms for generating the secondary statistics and Higher-order Statistics used to determine system health and user performance.

The central control and database 804 may reside with the provider of the observation platform, in the cloud, within the enterprise or in a commercially available server farm facility. The central control and database 804 may provide one or more Application Programming Interfaces (APIs) to any external systems 806 and information sources that may communicate with the users and devices within Environment 800. The central control and database 804 also provides encrypted and secure storage and access to computer systems 840 or 850.

External systems 806 may refer to external computer systems owned by the enterprise, third-party services, vendors or suppliers, or the provider of the observation platform. The external systems 806 may contain information that is pushed to users of the observation platform such as time-clock alerts, video analysis alerts, cross-channel or omni-channel support alerts, enterprise-wide or group-targeted messaging text or audio, automated status alerts or other information that would be useful to one or more users of the observation platform(s).

Additional external systems may provide information helpful to job or task performance such as inventory levels, procedural information, frequently asked questions, product information, recommended product information, similar product information, selling tips, task performance processes, security recommendations, geographical directions, corporate information, or simple information such as time and weather.

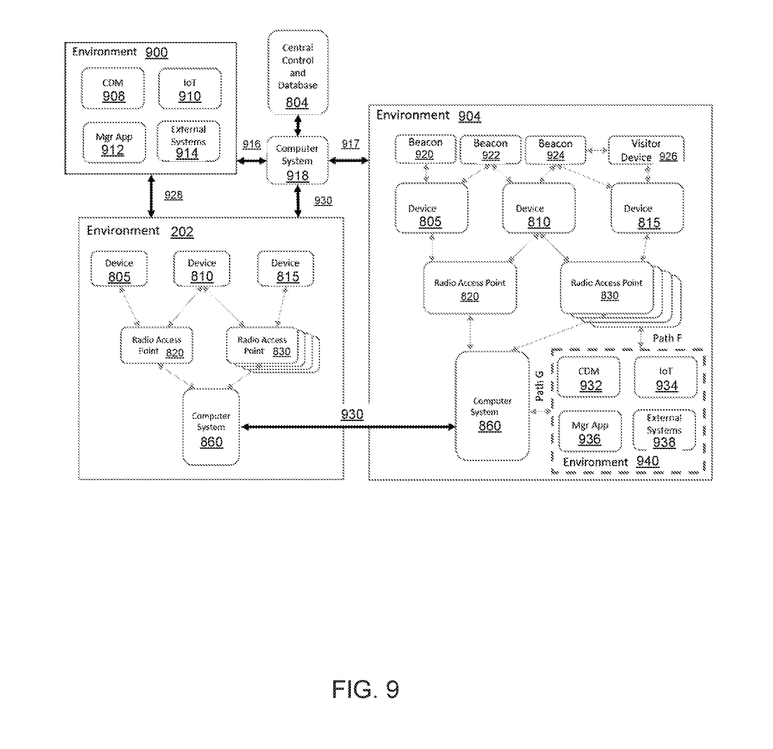

With reference now to FIG. 9, a block diagram of observation platforms including environments 900, 902, and 904. The environments 902 and 904 may comprise some or all of the features of environment 800 of FIG. 8. As compared to FIG. 8, FIG. 9 depicts additions of interconnections between observation platforms such as environments 902 and 904. FIG. 9 as adds a new environment depicted as environment 940, within the observation platform depicted as environment 904, that contains one or more systems or alternate devices such that may interact with the devices 805, 810, and 815 within environment 904 and hence users of the system. FIG. 9 also adds attaching a new environment depicted as environment 900 that contains one or more systems or alternate devices, such a CDM 932, an IOT 934, a mgr app 936, and external systems 938, that may interact with the devices 805, 810, and 815 of environments 902, 904, or other observation platforms and hence users of the system. It should be appreciated that environment 940 may also comprise a unique set of a CDM 932, an IOT 934, a mgr app 936, and external systems 938.

Interconnection of observation platforms allows information to be exchanged and structured across any set of locations, buildings, cities, or countries. The observation platforms, depicted in the environment 902 and 904, are usually connected under the control of the computer system 918 via path 917 and path 930. In one embodiment, the observation platform of environment 904 may directly communication with the observation platform of environment 902 via path 942. The computer system 918 mediates the communication between the sites, applies policy to the transiting information, and extracts statistical information for application to Secondary or Higher-order statistics used for performance evaluation of users or the system integrity. The computer system 918 may have features and capabilities and a purpose similar to the computer system 850 of FIG. 8. Environment 904 shows in detail how other devices within an observation platform environment can interact with user devices 805, 810 and 815, the radio access points 820 and 830, and the computer systems 860 and 918.

Beacon devices 920, 922, and 924 are typically small fixed or mobile devices that emit a signal to alert other devices that they are within a near proximity of the beacon. The beacon signal may contain identification information or other information useful to the receiving device. For example, visitor device 926 may detect the beacon 922 that causes a visitor device 926 to contact a separate system to receive special offers or information regarding the local proximity. The user devices 805, 810 and 815 of the environment 904 may be capable of receiving the beacon signal that may be used for proximity detection and location determination. Additionally, user devices 805, 810 and 815 of the environment 904 may be capable of transmitting a beacon signal to trigger actions in devices carried by visitors or shoppers. For example, the visitor device 926 may detect a beacon signal from the device 815 which causes the visitor device 926 to contact a separate system that in turn alerts the user of the device 815 that they are in proximity to a specific visitor or shopper along with information about that visitor or shopper. The observation platform might then communicate with an external system (e.g., external system 914 of environment 900 or 906) to receive instructions and potential offers for that visitor or shopper.

The environment 940 depicts a set of other possible devices that may reside either within the observation platform as shown in environment 904, or external to the observation platform environment as shown with environment 902 which is connected with path 928. The observation platform may use a plurality of methods to indicate the nature of connected systems and devices such as the differing sounds, audible differences in machine voices or recorded voices, or visible signals.

In one embodiment, the CDM 932 is a content distribution manager (CDM) browser that is a software application that is accessed via a uniform resource locator (URL) by any computing device that employs a web browser. The CDM 932 may comprise an application program interface (API) or graphical interface that is employed by a user of the CDM 932. A user of the CDM 932 may be required to provide authentication to access the CDM 932.

The CDM 932 is employed by a user to manage and control messages that are sent to a plurality of observation platform and the devices therein. In one embodiment, the CDM 932 can retrieve content for a message or can be employed to generate new and original content for a message. In one embodiment, the content is an audio file such as a WAV file that is the recording of an audible voice such that when the message is delivered to and accessed by a destination device, the message will playback the audible voice. The CDM 932 may be employed by a manager to record a voice message that is then delivered to a plurality of devices.

In one embodiment, a message controlled by the CDM 932 is delivered to a plurality of devices simultaneously. This may be accomplished by the CDM 932 sending out the message to the various devices at the same time, or CDM 932 may deliver the message to a plurality of observation platforms with commands or instructions to deliver the message to specified devices within the observation platform at a designated time. Delivering the messages to the devices may also be described as pushing the message. The manager using the CDM 932 may designate the time a message should be available for the users and how long that message should be available to hear (end time). Alternatively, the CDM 932 may be employed to deliver the same message to different devices at different times. For example, the message may be delivered to store managers within a set of observation platforms at a designated time before the message is delivered to other employees within the same set of observation platforms. The user of the CDM 932 may also specify that additional content or messages are sent to different devices. For example, additional content may be sent to store managers or additional content may be sent to devices associated with a specific department in a retail setting such as the painting department.

In one embodiment, the CDM 932 is employed to specify who or what devices are to receive the message with its content. For example, the user of the CDM 932 may have authority over several different environments each with its own observation platform. The user may wish that the message only be sent to specified observation platforms within the plurality of observation platforms. Alternatively, the user may specify that all of the devices within all of the observation platforms receive the message, or only devices located within the physical boundaries of the observation platform at the designated time receive the message, or only devices associated with a specific department receive the message or only devices associated with store employees and not customers receive the message. The possible options for specifying which devices receive a message and when are limitless. A message may also be generated and sent to a specific individual. In one embodiment, the CDM 932 uses groupings by role, department, district, and/or region to determine which devices play a given message. It should be appreciated that the content of the message may be a voice recording, but may also be other content such as text, images, or video. In one embodiment, the message is sent to a given device with a command to notify the user of the device that there is a message received. The notification may be a light, a blinking light, a specific color of light, a sound, a textual notification, or any other type of notification that the device is capable of providing.

The CDM 932 may be employed by a user that has high level access to the plurality of observation platforms. For example, a corporation may have hundreds or thousands of hospitality locations or store fronts that each makes use of an observation platform. The corporation may have a headquarters or central office with employees who have access to the CDM 932 with the ability and authority to send a message to anyone and everyone associated with the corporation.

In one embodiment, a device that receives a message from the CDM 932 automatically sends a confirmation back to the CDM 932 that the message has been received. Additionally, once the message has been accessed or heard by the user of the device, the device may send a message back to the CDM 932 that the messaged has been heard or otherwise accessed. In one embodiment, the message may be a mandatory message that the user of the device is required to access a, listen to and then acknowledge hearing.

Another possible element of environment 940 is the manager application depicted as mgr app 936. In one embodiment, the mgr app 936 is a software application or app that is accessed via a mobile computer system such as a smartphone or tablet. In one embodiment, the mobile computer system executes an Android operating system. In one embodiment, the mobile computer system executes an iOS operating system. Other operating systems may also be employed. The mgr app 936 may be an app available for download and installation on the mobile computer system. The mgr app 936 is designed with an API or graphical interface specific to a mobile computer system such as a smart phone and to be used in the field by a user or manager associated with at least one observation platform. The user of the mgr app 936 may be a regional manager that has access to a plurality of observation platforms. The regional manager may regularly travel between the physical locations of the plurality of observation platforms and needs to have access to the observation platforms while physically remote and in the field on the go. The mgr app may also be used by corporate headquarters personnel and by support personnel for either the enterprise or third party support of the enterprise.

In one embodiment, the mgr app 936 allows the user of the mgr app 936 to communicate with or monitor any device or plurality of devices within any of the observation platforms associated with the user. The mgr app 936 also is able to report statistics or observe or monitor communications with any of the observation platforms associated with the user. For example, the mgr app 936 may be able to listen in to communications happening in real time within an observation platform or may be able to play back past recorded communications. In one embodiment, the manager application may operate in a manner identical to the mobile devices in the observation platform as a peer-like device. In this mode the manager application may broadcast or direct communications to specific devices, receive alerts and provide both a primary signal for communication and a secondary signal for determining geographic location. In one embodiment, the peer-like device may be able to operate and interact with devices within an observation platform without directly communicating with a central computer system. In other words, the central computer system may or may not be required for receiving and relaying messages from the manager application. The mgr app 936 may also be employed to send announcements or messages similar to the CDM 932. The mgr app 936 may communicate directly through a network with a given observation platform or may use the external communications paths 914, 916, and 930.

Another possible element of environment 940 is an Internet of Things (IoT) device depicted as IoT 934. An observation platform may be associated with external devices including a growing list of electronic devices that communicate with each other or with one or more systems providing status, alerts and other useful command/control information. These external devices are able to operate in an observation platform and communicate using formatted data strings and standard internet protocols for communication across the internet. These external devices may be referred to as the Internet of Things (IoT).

Specifically, IoT 934 depicts a wide array of IoT devices that can use the observation platform for alerting selected users of actions needed or that may query selected users for additional information or may query the observation platform for user contextual information or may allow users to instruct or control the IoT devices based on user context and policy. Environment 940 comprises components that may or may not be used with different embodiments of the present technology and should not be construed to limit the present technology.

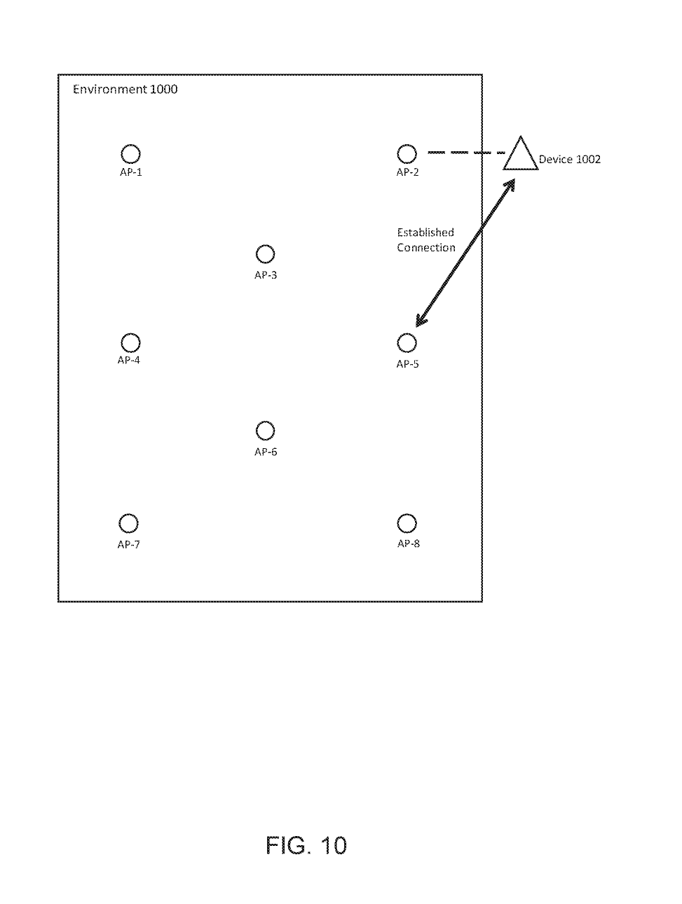

With reference to FIG. 10, a block diagram of an environment for predictive roaming for inhibiting sleep mode during contiguous conversations according to an example of the present technology. Device 1002 may be a communication device with the same features and capabilities of communication device 120 of FIG. 1. FIG. 10 depicts environment 1000 which may be a defined geographic area. The defined geographic area may represent a confined or closed area in which resides a plurality of access points depicted by AP-1 through AP-8. The device 1002 is depicted as having an established connected to the access point AP-5. The dotted line represents a potential hand over to the access point AP-2. The device 1002 may be equipped or programmed with a power-saving mode or sleep mode. During a contiguous conversation with a central computer, the device 1002 may switch off any power-saving mode or sleep mode for the duration of the conversation. This may be accomplished using a process described in the following example.

First, the device 1002 begins in a normal power-saving mode (doze state or sleep mode) until a communication is initiated. Upon receiving or transmitting a contiguous conversation as determined by application layer protocols for the device 1002, the power-saving mode is switched off and doze state is inhibited. The device 1002 inhibits power-saving mode throughout the contiguous conversation as determined by application layer protocols. Handovers between access points may take place as needed. Upon an end-of-file protocol indication in the application layer, the device 1002 returns to normal power-saving mode.

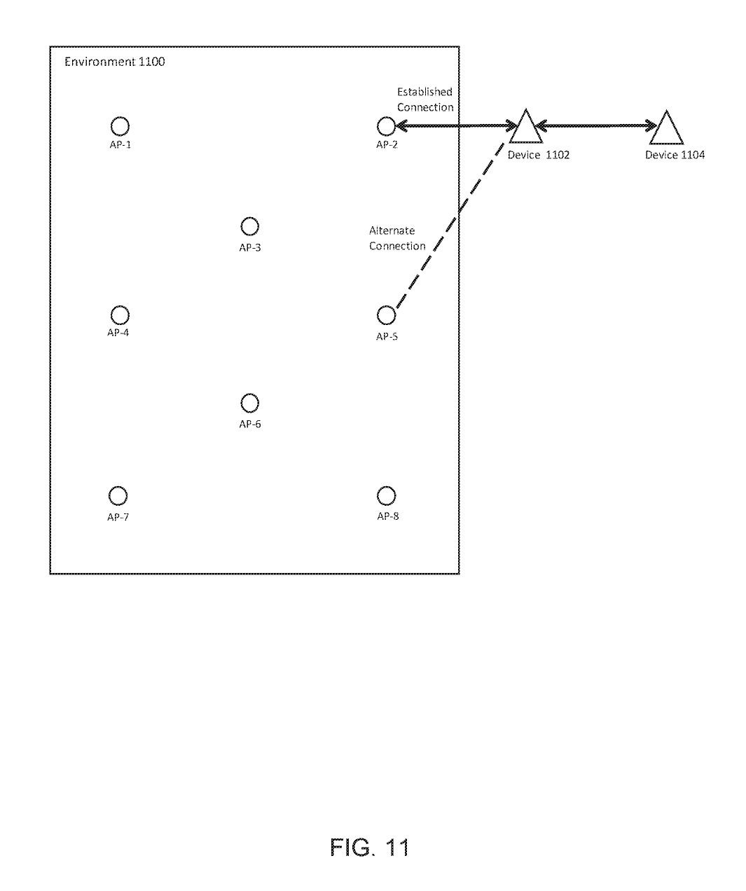

With reference to FIG. 11, a block diagram of an environment for using mobile devices as repeaters. Device 1102 and device 1104 may be communication devices with the same features and capabilities of communication device 120 of FIG. 1. FIG. 11 depicts environment 1100 which may be a defined geographic area. The defined geographic area may represent a confined or closed area in which resides a plurality of access points depicted by AP-1 through AP-8. The device 1102 is depicted as having an established connected to the access point AP-2. The dotted line represents a potential hand over to the access point AP-5. In one embodiment, the device 1104 is out of range for reliable communications for an access point within the environment 1100. The device 1104 is able to determine that the device 1102 is within communication range for an access point within the environment 1100. The device 1102 is then able to act as a repeater for communications between the device 1104 and an access point within the environment 1104. In one embodiment, the device 1102 manages the connection to an access point for the device 1104 including potential handovers between access points. In one embodiment, the device 1104 comes within range for a reliable connection to an access point within the environment 1100 and the device 1104 stop using the device 1102 as a repeater and switches to directly connecting to an access point.

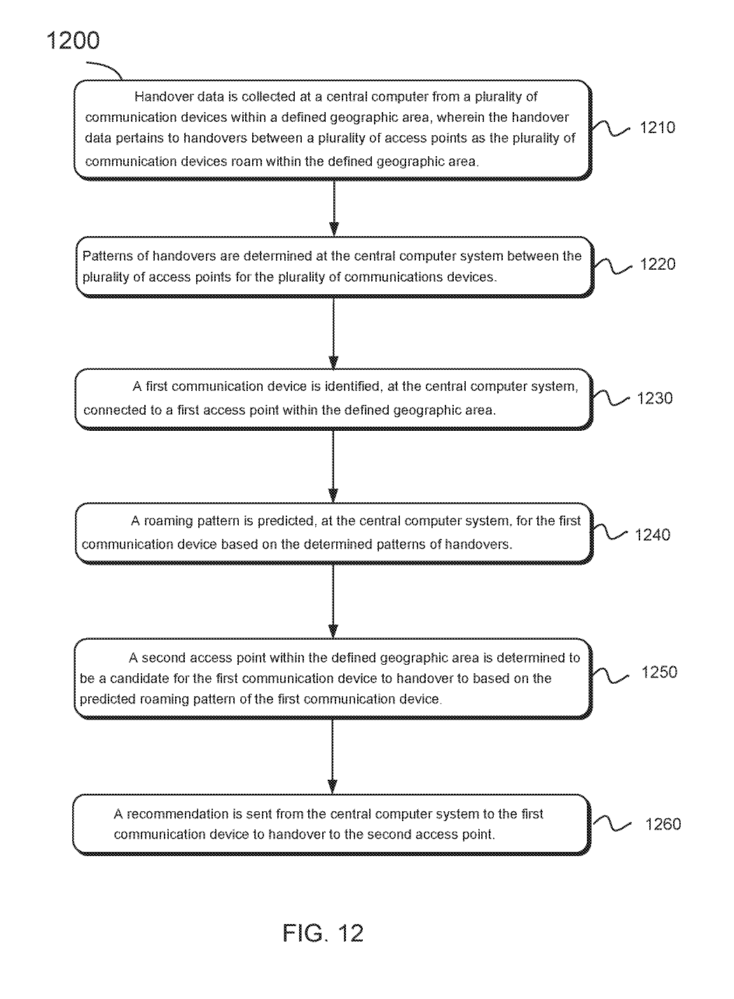

FIG. 12 is a flowchart of an example method 1200 for recommending handovers between access points according to an example of the present technology. The functionality 1200 may be implemented as a method and executed as instructions on a machine, where the instructions are included on at least one computer readable medium or one non-transitory machine-readable storage medium. For example, starting in block 1210, handover data is collected at a central computer from a plurality of communication devices within a defined geographic area, wherein the handover data pertains to handovers between a plurality of access points as the plurality of communication devices roam within the defined geographic area. Patterns of handovers are determined at the central computer system between the plurality of access points for the plurality of communications devices, as in block 1220. A first communication device is identified, at the central computer system, connected to a first access point within the defined geographic area, as in block 1230. A roaming pattern is predicted, at the central computer system, for the first communication device based on the determined patterns of handovers, as in block 1240. A second access point within the defined geographic area is determined to be a candidate for the first communication device to handover based on the predicted roaming pattern of the first communication device, as in block 1250. A recommendation is sent from the central computer system to the first communication device to handover to the second access point, as in block 1260.

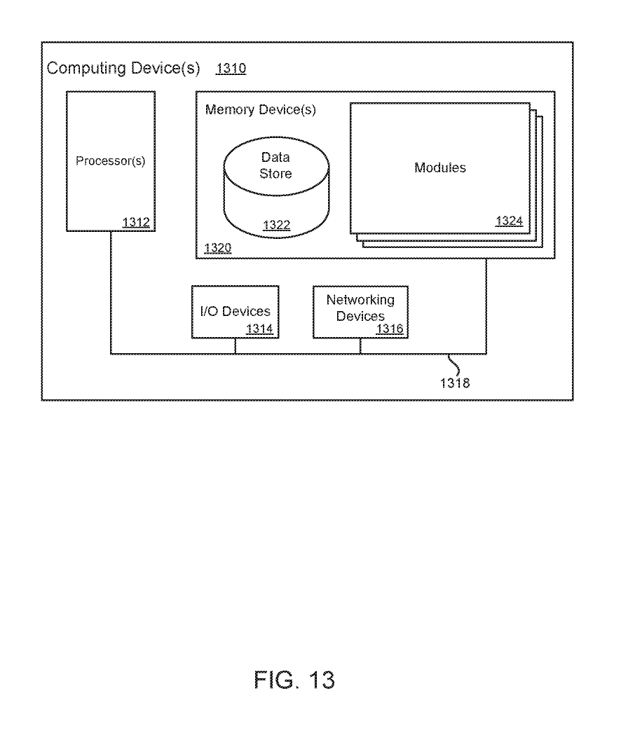

FIG. 13 illustrates a computing device 1310 on which modules of this technology may execute. A computing device 1310 is illustrated on which a high level example of the technology may be executed. The computing device 1310 may include one or more processors 1312 that are in communication with memory devices 1320. The computing device may include a local communication interface 1318 for the components in the computing device. For example, the local communication interface may be a local data bus and/or any related address or control busses as may be desired. For example, the computing device 1310 may be central computers or communication devices of FIGS. 1-3.

The memory device 1320 may contain modules 1324 that are executable by the processor(s) 1312 and data for the modules 1324. The modules 1324 may execute the functions described earlier. A data store 1322 may also be located in the memory device 1320 for storing data related to the modules 1324 and other applications along with an operating system that is executable by the processor(s) 1312.

Other applications may also be stored in the memory device 1320 and may be executable by the processor(s) 1312. Components or modules discussed in this description that may be implemented in the form of software using high programming level languages that are compiled, interpreted or executed using a hybrid of the methods.

The computing device may also have access to I/O (input/output) devices 1313 that are usable by the computing devices. An example of an I/O device is a display screen that is available to display output from the computing devices. Other known I/O device may be used with the computing device as desired. Networking devices 1316 and similar communication devices may be included in the computing device. The networking devices 1316 may be wired or wireless networking devices that connect to the Internet, a LAN, WAN, or other computing network.

The components or modules that are shown as being stored in the memory device 1320 may be executed by the processor 1312. The term “executable” may mean a program file that is in a form that may be executed by a processor 1312. For example, a program in a higher level language may be compiled into machine code in a format that may be loaded into a random access portion of the memory device 1320 and executed by the processor 1312, or source code may be loaded by another executable program and interpreted to generate instructions in a random access portion of the memory to be executed by a processor. The executable program may be stored in any portion or component of the memory device 1320. For example, the memory device 1320 may be random access memory (RAM), read only memory (ROM), flash memory, a solid-state drive, memory card, a hard drive, optical disk, floppy disk, magnetic tape, or any other memory components.

The processor 1312 may represent multiple processors and the memory 1320 may represent multiple memory units that operate in parallel to the processing circuits. This may provide parallel processing channels for the processes and data in the system. The local interface 1318 may be used as a network to facilitate communication between any of the multiple processors and multiple memories. The local interface 1318 may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configuration definitions, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Reference was made to the examples illustrated in the drawings, and specific language was used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

1. A method for recommending handovers between access points, comprising:
collecting handover data at a central computer from a plurality of communication devices within a defined geographic area, wherein the handover data pertains to handovers between a plurality of access points as the plurality of communication devices roam within the defined geographic area;
determining patterns of handovers at the central computer system between the plurality of access points for the plurality of communications devices;
identifying, at the central computer system, a first communication device connected to a first access point within the defined geographic area;
predicting, at the central computer system, a roaming pattern for the first communication device based on the determined patterns of handovers;
determining, at the central computer system, a second access point within the defined geographic area as a candidate for the first communication device to handover to, based on the predicted roaming pattern of the first communication device; and
sending a recommendation from the central computer system to the first communication device to handover to the second access point.

2. The method as recited in claim 1, wherein the first communication device performs a handover from the first access point to the second access point based on the recommendation from the central computer system.

3. The method as recited in claim 2, further comprising:
determining, at the central computer system, a third access point within the defined geographic area as a candidate for the first communication device to handover to from the second access point based on the predicted roaming pattern of the first communication device.

4. The method as recited in claim 1, wherein the first communication device does not perform a handover to the second access point and then moves to a new location within the defined geographic area, the central computer system then determines a third access point as a candidate for handover based on the new location.

5. The method as recited in claim 1, wherein the plurality of access points and the plurality of communication devices employ an 802.11 standard protocol to connect.

6. The method as recited in claim 1, wherein a new communication device entering the defined geographic area is enabled with the best candidate access point for handover based on the roaming patterns of the plurality communications devices already operating within the defined geographic area.

7. The method as recited in claim 1, wherein the collecting the handover data at the central computer system comprises the plurality of communication devices sending one or more parameters related to a location and a quality of data received from an access point.

8. The method as recited in claim 1, wherein the determining a second access point is determined without performing a background scan at the first communication device.

9. The method as recited in claim 1, wherein the recommendation comprises a ranked list of potential access points for the first communication device to handover from the first access point.

10. The method as recited in claim 9, wherein the determining a second access point is determined by performing a limited background scan of the ranked list of potential access points at the first communication device.

11. The method as recited in claim 1, wherein a handover to the second access point is triggered by a degradation between the first access point and the first communication device in at least one of signal strength (RSSI), packet loss, packet delay, packet jitter, and/or missed beacons, audio codec buffer underrun.

12. The method as recited in claim 1, wherein the first communication device forces a data rate between the first access point and the first communication device to decrease or increase based on at least one of signal strength (RSSI), packet loss, packet delay, packet jitter, missed beacons, and/or audio codec buffer underrun.

13. The method as recited in claim 1, wherein the first communication device uses historical information derived from and computed within the first communication device without connection to the central computer to reduce the number of access points that are scanned in the background.

14. The method as recited in claim 1, wherein the collecting the handover data comprises data selected from the group of data consisting of: connected access point data, connected access point signal strength (RSSI) data, data rate between the first communication device and the first access point, background scan results, receive and transmit retries, packet delay and jitter, roam time to the first access point, missed beacon counts, average beacon receive time, neighbor access point list received from the first access point, interference report from the first access point, data used to derive the geolocation of the first communication device, and 9-axis inertial sensor output for direction and speed.

15. The method as recited in claim 1, wherein the determining the patterns of handovers is also determined based on historic handover data for the defined geographic area, wherein the historic handover data is received at the central computer system from cloud storage.

16. The method as recited in claim 1, further comprising:
determining that a traffic type for data sent between the first communication device and the first access point is voice data; and
wherein the determining the second access point as the candidate for handover is based in part on the traffic type.

17. The method as recited in claim 1, further comprising:
determining that a number of communication devices connected to each of the plurality of access points; and
wherein the determining the second access point as the candidate for handover is based on the number of communication devices connected to the second access point.

18. The method as recited in claim 1, wherein the determining the second access point further comprises determining a ranked list of potential access points based on a weighted calculation performed by the central computer system.

19. A non-transitory machine readable storage medium having instructions embodied thereon, the instructions when executed cause a processor to perform a method for recommending handovers between access points, the method comprising:
collecting handover data at a central computer from a plurality of communication devices within a defined geographic area, wherein the handover data pertains to handovers between a plurality of access points as the plurality of communication devices roam within the defined geographic area;
determining patterns of handovers at the central computer system between the plurality of access points for the plurality of communications devices;
identifying, at the central computer system, a first communication device connected to a first access point within the defined geographic area;
predicting, at the central computer system, a roaming pattern for the first communication the communication device based on the determined patterns of handovers;
determining, at the central computer system, a second access point within the defined geographic area as a candidate for the first communication device to handover to, based on the predicted roaming pattern of the first communication device; and
sending a recommendation from the central computer system to the first communication device to handover to the second access point.

20. A system for recommending handovers between access points, comprising:
a central computer system with a processor and memory configured to:
collect handover data at a central computer from a plurality of communication devices within a defined geographic area, wherein the handover data pertains to handovers between a plurality of access points as the plurality of communication devices roam within the defined geographic area;
determine patterns of handovers at the central computer system between the plurality of access points for the plurality of communications devices;
identify, at the central computer system, a first communication device connected to a first access point within the defined geographic area;
predict, at the central computer system, a roaming pattern for the first communication the communication device based on the determined patterns of handovers;
determine, at the central computer system, a second access point within the defined geographic area as a candidate for the first communication device to handover to, based on the predicted roaming pattern of the first communication device; and
send a recommendation from the central computer system to the first communication device to handover to the second access point.

21. The system as recited in claim 20, further comprising:
the first communication device configured to perform a handover from the first access point to the second access point based on the recommendation from the central computer system.
